(19) United States
(12) Patent Application Publication
(10) Pub. No.: US 2008/0041644 A1
(43) Pub. Date: Feb. 21, 2008

(54) Electric shopping cart/burden carrier

(76) Inventors: Arthur L. Tudek, Glassport, PA (US); Arthur Paul Tudek, Minot, ND (US)

Correspondence Address: ARTHUR L. TUDEK, 507 INDIANA AVENUE, GLASSPORT, PA, 15045, US

(21) Appl. No.: 11/504,298

(22) Filed: Aug. 16, 2006

(51) Int. Cl. B60K 1/00

(52) U.S. Cl. 180/65.1

(57) ABSTRACT

A battery powered, electric motorized cart and burden carrier which may be manually pushed or pulled to a shopping area for use during shopping and for transporting merchandise thereafter. Battery powered motors and gearing associated with the rear driving wheels are controlled from a control box on a lanyard attached to the cart so that the loaded cart may be either operated and controlled by an individual walking in front or the rear thereof. Steering is effected through the swivelly mounted front wheels by the operating exerting a tug on the lanyard or applying forward pressure to the rear of the cart when the control box is arranged and supported thereat. Battery charging may be accomplished by actuating a control box switch to close the circuit to the battery and manually pushing the cart to rotate the motor shafts and cycle the amperage back into the battery. Another way is to utilize an alternating current charging adapter.

### BRIEF SUMMARY OF THE INVENTION

This invention relates to an electric motor and battery powered wheeled shopping cart and burden carrier manually pushable or pullable to a shopping area for use during shopping and for thereafter transporting merchandise under motor power by the operator walking along therewith and controlling the dual motors and gearing associated with the rear drive wheels and the travel thereof through the medium of a hand held or cart mounted control device on a lanyard attached to the cart, and whereby charging of the battery may be effected by closing the circuit to the battery and manually pushing the cart to rotate the motor shafts and cycle the amperage back into the battery.

### CROSS REFERENCE TO THE PRIOR ART

While it has heretofore been proposed to provide a shopping service cart with a motorized wheel assembly unit, such as that of Swinny U.S. Pat. No. 3,190,386, and the self-propelled power units for picking up and handling unpowered shopping carts of Hudson U.S. Pat. No. 3,073,404 and Vokes U.S. Pat. No. 3,524,512, and a wheel chair driving and steering apparatus of Schmidt U.S. Pat. No. 2,978,053, none of these devices suggest a self-contained electric motor and battery propelled shopping cart which may be manually pushable or pullable to a shopping area and thereafter returned when loaded under power controlled by the operator walking along therewith and controlling its speed and travel by a control unit arranged on a lanyard attached to the cart.

### SUMMARY OF THE INVENTION

The principal object of this present invention is to provide a shopping service cart and burden carrier having dual electric motors and gearing associated with the rear driving wheels on the flat undercarriage thereof and with a storage battery interposed therebetween, and wherein a lanyard attached to the cart has a hand holdable control unit thereon for controling the speed and travel of the cart under power, and whereby the cart may also be manually pushed or pulled without power.

Another object is the provision of a shopping service cart or the like wherein the main body storage area consists of a front end wall having an inverted U-shaped handle frame with wire mesh extending therebetween, a pair of wire mesh sides, and a generally rectangular insulated, hinged top storage chest at the rear end and also having an inverted U-shaped handle frame attached thereto, and wherein the walls and chest are removably interconnected and mounted on the flat undercarriage for disassembly and flat storage of the these components, as well as the separate use of the undercarriage.

A further object is to provide a shopping service cart or the like wherein the lanyard fixedly attached thereto has a control unit arranged on the outer end thereof in which the motor controls and wiring are housed with the wiring extending through the lanyard to the battery and dual motors, so that the control unit may either be hand held for actuation by the operator walking in front of the cart or mounted on the rear handle for actuation by the operator from the rear.

Still another object is the provision of a shopping service cart or the like wherein the battery thereof may be charged by actuation of switching means on the lanyard control unit to close the circuit to the battery and permit manual pushing of the cart in reverse so that no power is transmitted to the rear wheel gear trains and opposite rotation of the driving wheels causes the gears to rotate the motor shafts and act as a charging, direct current generator to produce current and cycle the amperage back into the battery.

These and other objects and advantages will be apparent as the specification is considered with the accompaying drawings. wherein

FIG. 1 is perspective view of an assebled cart showing the operator leading and controlling by the hand held control unit on the lanyard.

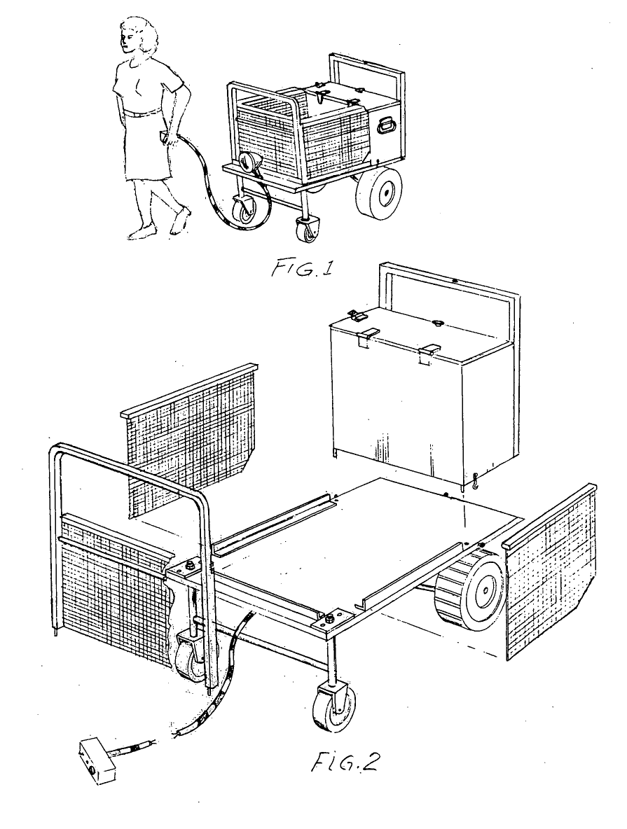

FIG. 2 is an exploded perspective of cart with storage components disassembled from the undercarriage thereof;

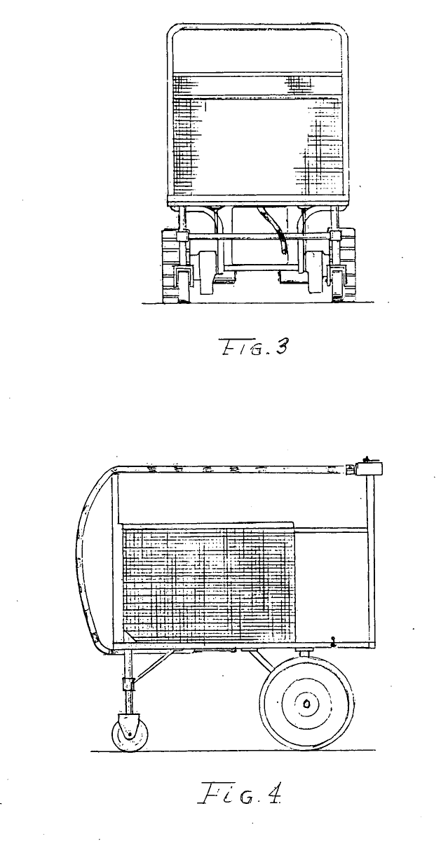

FIG. 3 is a front elevation;

FIG. 4 is a side elevation, showing the lanyard control unit mounted on the rear handle;

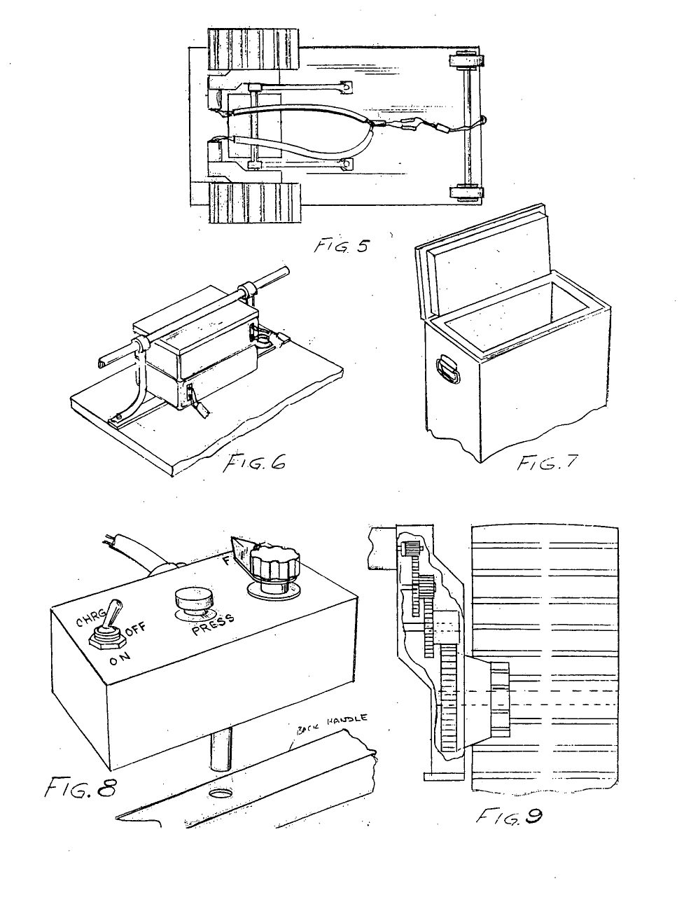

FIG. 5 is a bottom plan view, showing the battery, dual motor, gear and wheel assemblies;

FIG. 6 is a bottom perspective view of the rear axle and battery assembly;

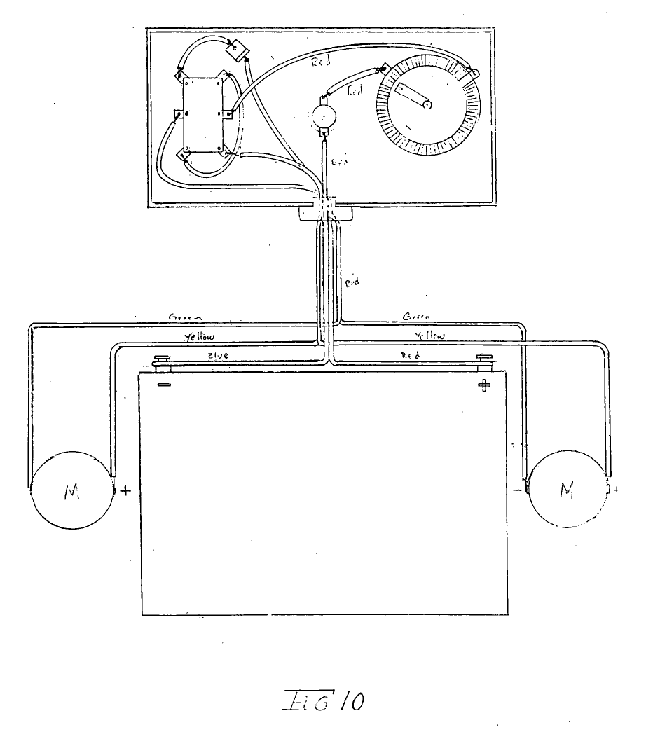

FIG. 7 is a perspective view, partly broken away, of the insulated storage chest with top elevated;

FIG. 8 is a perspective view of the lanyard control unit when mounted on the rear handle;

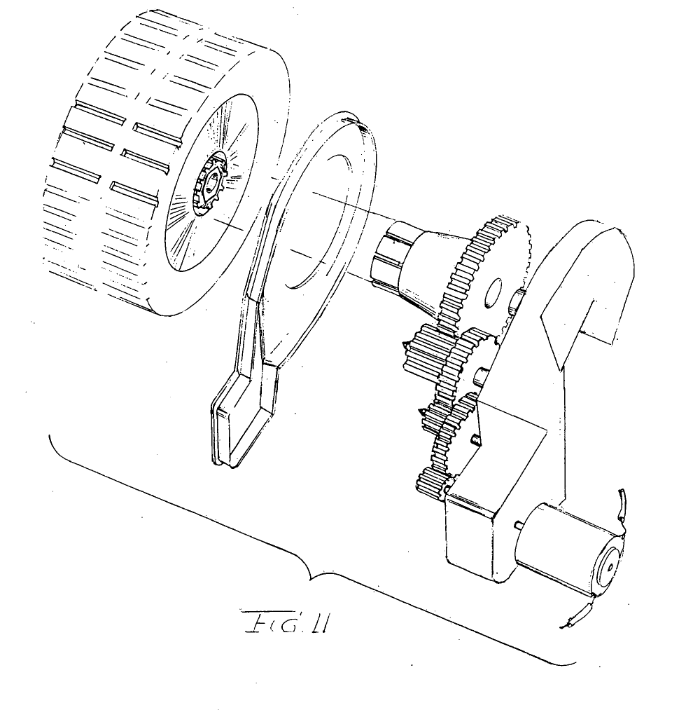

FIG. 9 is a plan view of a rear drive wheel with its associated gear box broken away to show a gear train therein;

FIG. 10 is a diagrammatic view of the control circuit from the lanyard control unit to the battery and dual motors;

FIG. 11 is an exploded perspective view of a rear driving wheel, and its associated gear box, gear train, and D.C. motor.

### DETAILED DESCRIPTION

Referring more particularly to the drawings, wherein similar reference characters designate like part throughout the several views, the herein and about to be described shopping service cart generally approximates in size, height and shape a conventional basket type shopping cart of the type employed in retail grocery establishments and includes a generally rectangular flat undercarriage 1 having a pair of suitable driving or traction wheels 3 of suitable flow-molded plastic arranged on an aluminum axle 2 suspended and supported beneath the undercarriage 1 adjacent its rear end 4 by suitable brackets 5. In the interest of reducing weight, the undercarriage 1 may be of a suitable high impact plastic, or aluminum. Supported by posts 6 suitably mounted in and depending from the front corners of the undercarriage 1 are a pair of smaller suitable wheels or casters 7 swivelly mounted, as at 8, to the lower ends of the posts. A brace rod 9 extends between and serves to retain the posts in position. The rear wheels 3 are larger than the front wheels 7 and, as presently to be described, serve to propel the undercarriage and cart, whereas the smaller wheels, being swively mounted, enable the cart to be steered in an obvious manner.

Removably supported on the upper surface of undercarriage 1 is a storage compartment 10 which includes a generally rectangular chest 11 having a top 12 hinged, as at 13, and a suitable latch 14. The chest may be formed of any suitable material and have an insulated lining, not shown, so that frozen packages and the like may be housed therein. Suitably affixed to a wall of the chest is an inverted U-sghaped tubular aluminum pipe 15 projecting a suitable distance above the top of 12 to provide a rear handle portion 16. The chest may have suitable trunk handles 17 on the end walls thereof to facilitate handling thereof, and is preferably arranged at one end of the undercarriage 1, such as the end above the rear drive wheels 3. Dowel pins 3 may be provided at the lower corners of the chest for interfitting holes 19 in the undercarriage, and suitable latches 20 arranged thereon for securely but removably mounting and anchoring the chest on the undercarriage. Projecting upwardly from, and extending across the front end of the undercarriage is a front panel 21 of aluminum wire mesh 22 or suitable plastic of a height corresponding to that of chest 11, suitably attached to an inverted U-shaped tubular aluminum pipe 23 projecting a suitable distance above the top 24 of the panel to provide a forward handle portion 25. Dowel pins or the like 26 on the lower ends of pipe 23 interfit holes 27 in the undercarriage. Side panels 28-29, similar to front panel 21 and extending therefrom to the rear wall 30 of chest 11, may interfit suitable channels 32, and the other ends of panels 28-29 may be removably attached, in any suitable manner, such as, by latches, not shown, to front panel 21. The lower ends of the front and side panels may engage with L-shaped angles bars 32, attached to the upper surface of undercarriage 1, so as to assist in retaining these components thereon. Thus, it will be evident that the various storage comprtment units are securely, but removably, arranged on the undercarriage, and permit the latter to be used independently thereof when desired, as well as to facilitate storage.

As best shown in FIGS. 3,5 and 11, the shopping cart and the rear traction wheels 3 thereof are power operated by a pair of relatively small conventional 6-12 volt, D.C. electric motors 33, suitably mounted on and oppositely projecting inwardly from gear boxes 34 suitably mounted on an supported by rear axle 2 parallel to and adjacent the inner side of each wheel. Referring to FIGS. 9 and 11, each motor 33 is so positioned that the armature shaft 35 thereof extends through an inner side wall 36 of the gear box and actuates the smallest gear 38 of a train of worm gears 37. The largest gear 39 thereof is formed with a hub 40 which projects through as outer wall 41 or its gear box and drivingly interengages with a hub 42 of the wheel. Axle 2 projects through the gear boxes and the largest gears 39 thereof and through the wheel hubs 42, so it will be apparent that the traction wheels 3 will be rotated and driven thereon in an obvious manner.

A conventional 12 volt storage battery 43 is securely mounted and suspended beneath the undercarriage on a base plate 44 suitable horizontally affixed to the axle 2 and between the supporting brackets 5 thereof so that the battery top abuts the undercarriage and is suitably fixedly so positioned, as best in FIG. 6. Battery 43 is electrically connected to each of the motors 33 so that when a control unit, presently to be described, is actuated the traction wheels will be driven.

An important feature hereof is the provision of a remote control operable by the user when walking in front and ahead or astern of the cart and maneuvering and controlling its rate of travel. Thus, an electrical lanyard or cable 45, of any suitble material, such as, rubber or plastic, which is sufficiently strong and yet flexible to enable the used exerting an appropriate tug thereon when steering of the front wheels or casters 7, is required and may be suitably securely anchored to the middle of the front brace rod 9.

Lanyard 45 is of sufficient length so that a control box 46 on the outer end thereof may be grasped in a hand of the user when walking ahead of the cart, or may be extended rearwardly over the storage compartment 10, as shown in FIG. 4, where it may be mounted and supported on the rear handle 16. A group of conductor wires 47 are encased within the lanyard and extend from within the control box 46 to a point intermediate the ends of the undercarriage where they project from the terminal and of the lanyard and are electrically connected to the posts of the battery 43 and the motors 33, as shown in the diagram of FIG. 10.

The control box 46 is generally rectangular and of a size for grasping and holding in a hand of the user when leading the cart, as in FIG. 1. A dowel pin 48 projecting from one side wall of the box may be inserted in a hole 49 in rear handle 16 to support the box thereat, as in FIG. 4, and thereby enable the cart to be controlled from the rear, as will hereinafter be described. Now referring to FIGS. 6 and 10, suitably arranged in control box 46 are a conventional rheostat 50, conventional spring loaded push button switch 51, normally open when released, closed when depressed, conventional double pole double throw cross wire (D.P.D.T.) switch 51, and conventional blocking diode 53, which are connected with the conductor wires 47. It will be noted that the controls for the switches 51 and 52 and the rotatable knob for the rheostat are arranged on the top of the box so as to be available for actuation, whereby switch 51 controls power to the motors 33, with the circuit to the battery and motors being closed when pressure is applied thereto; rheostat 50 functions to vary the voltage and speed of the motors; and the rotatable knob of the rheostat 50 also functions to hold down the push button switch 51 when this rotatable knob is swung over 51 thus closing the circuit and the D.P.D.T. switch control 52 can be placed in the charging mode D.P.D.T. switch 52 reverses the polarity of the current; and the blocking diode 53 allow current to flow one way to activate motors 33, blocking the current when the D.P.D.T. switch 52 is reversed thus to stop the current flow from the battery to stop the motors.

It will be understood that the cart may be readily operated by a walking operator and, by dismantling the storage compartment components from the undercarriage, enable suitable storage thereof, as well as permitting the individual and seperate use of the undercarriage as a truck. The most significant use would be as a shopping service cart, in which event the operator may push the cart, either or without power, to the supermarket and continue pushing it thereat without power until shopping is completed with any frozen food stored in the insulated chest. After checking out and leaving, the operator may stand behind the loaded cart, grasping the rear handle thereof, and, after first pushing the cart to impart movement thereto, actuate the controls on the control box thereon, and guiding under power of the motors so that any terrain may be travelled without effort by the operator, other than steering. The cart may also be controlled and operated with the operator in the lead and the lanyard control box in hand so that the cart trails under power and is steered by tugs on the lanyard. as low gearing trains are arranged in the gear boxes associated with the rear traction wheels, no brake system is required. When being operated under power and an upgrade is encountered, the cart will slow down and then be controlled by the operator. On the other hand, on a downgrade the cart will coast at a very slow rate and is controllable with a little restraint.

Charging of the storage battery 43 is effected by actuating D.P.D.T. switch 52 to its designated charging position and the rotatable knob of the rheostat control 50 is rotated directly over the push button switch 51 to hold it down and keep the circuit closed, and by the operator pushing the cart in reverse without electric power so that the traction wheels rotate clockwise and similarly rotate the motor shafts 35 through the trains of gearing 37. Thus the D.C. motors 33 will be driven in reverse of their wired polarity to act as generators producing current cycling the amperage back into and charging the battery. During the charging operation, heat will be dissipated from the armatures and brushes which gives longer life to these components. In the usual electrically operated rider operated vehicles, such as, a power lawn mower or golf cart, a large initial amount of current is required to get the vehicle moving until it can build up needed electrical force or breakway power, which usually is about three times that required to operate the vehicle. On the other hand, it is only necessary for the operator to get the present cart moving a few feet before starting the motors so that breakway power is not needed, and a saving in electrical energy effected.

While a preferred embodiement of a electrically powered shopping service cart has been shown and described, it is to be understood that various changes and improvements may be made therein without departing from the scope and spirit of the appended claims.

What I claim is:

1. An electric battery powered shopping and service cart controlled and actuated by a walking operator comprising a flat undercarriage, a traction wheel axle suspended beneath the rear end of said undercarriage, a pair of traction wheels arranged on said axle, a pair of wheels swively mounted at the front end of said undercarriage, storage battery means supported beneath said undercarriage between said traction wheels, gear boxes fixedly supported by said axle adjacent each of said traction wheels and having gear trains therein, electric motor means supported by and extending inwardly from each of said gear boxes with the armature shafts thereof being in driving engagement with gears in said gear trains, and other gears in said gear trains being in driving engagement with said traction wheels, a rear panel having an upstanding handle located above said traction wheel axle, front and side panels of wire mesh, said flat undercarriage, front, side and rear panels forming a storage enclosure, an elongated flexible control lanyard attached to the front end of said undercarriage and having conducting wires extending therethrough for electrical connection with said battery means and said motor means, and control box means on the free end of said lanyard, said control box means having manually controllable switch means connected with said conductor wires whereby the operator may grasp said control box means when walking in the lead or astern of said cart and actuate said switch means to control the operation of said motor means and the forward travel of said cart.

2. In a device according to claim 1, including insulated storage chest means mounted on and removably connected to said undercarriage and forming a storage area and wherein said control box means includes starting and stopping switch means, and rheostat control means for controlling the speed of said motor and cart.

3. In a device according to claim 1, wherein charging switch means is included in said control box means to enable the circuit between said battery and motor means to be closed whereby said cart may be manually pushed forwardly or in reverse by the operator to charge said battery means.

4. In a device according to claim 2, wherein said storage chest means has a hinged top and is insulated, and said upstanding rear handle means is arranged rearwardly thereof.

5. In a device according to claim 4, wherein together with front handle means is upstanding relative to said front panel.

6. In a device according to claim 5, wherein said front and rear handle means include inverted generally U-shaped pipe means extending and spaced above said panels and storage chest means providing hand engageable handles.

7. In a device according to claim 6, wherein said panels and said storage chest means may be dismantled from said undercarriage for storage and to enable the independent and separate use of said undercarriage as a truck.

8. In a device according to claim 3, wherein said starting and stopping means includes a spring loaded pushbutton switch, and said charging switch means is a double pole, double throw cross wire switch, and rheostat and blocking diode means in circuit therewith.

9. In a device according to claim 1, wherein said lanyard is of a length sufficient to extend to said rear handle, and said control box has dowel pin means thereon insertable in said rear handle whereby said control box is mountable thereon and permits control of the cart by the operator when walking astern thereof.
